(19) United States
(12) Patent Application Publication
(10) Pub. No.: US 2008/0136343 A1
(43) Pub. Date: Jun. 12, 2008

(54) Resonant DC/AC inverter

(76) Inventors: Chung-Che Yu, Taipei (TW); Chien-Cheng Yang, Taipei (TW)

Correspondence Address: JOHN CHEN, ROOM 303, 3F, NO. 25, SEC. 1, CHANGAN E. ROAD, TAIPEI, 10441, omitted

(21) Appl. No.: 11/201,999

(22) Filed: Aug. 11, 2005

(51) Int. Cl. H05B 37/02; H02M 7/5387; H05B 41/36

(52) U.S. Cl. 315/219; 363/132; 315/291

(57) ABSTRACT

A resonant DC/AC inverter includes a DC power source providing a DC voltage, a half-bridge power switch circuit electrically connected to the DC power source being operative to convert the DC voltage to an AC voltage, a resonant tank electrically connected between an output of the half-bridge power switch circuit and an input of a load being operative to boost and filter the AC voltage to generate an AC power voltage supplied to the load, and a controller being operative to detect a magnitude of current in the load and a magnitude of a voltage across the load and to generate pulse waveforms for turning on and off the half-bridge power switch circuit, wherein the controller substantially instantaneously varies a frequency of the pulse waveforms and a duty cycle of the pulse waveforms so as to operate the resonant DC/AC inverter near a neighborhood of a resonant frequency of the resonant tank regardless of a conduction state of the load and improve the efficiency of the inverter regardless of the higher DC voltage applied to the inverter. Particularly, the resonant DC/AC inverter utilizes a piezoelectric transformer to supply power to a fluorescent lamp which is wildly employed in display panels and is extensively used to provide backlighting for liquid crystal displays (LCDs), especially for backlighting LCD monitors and LCD televisions.

### BACKGROUND OF THE PRESENT INVENTION

1. Field of Invention

The present invention relates to a resonant DC/AC inverter, and more particularly to a resonant half-bridge DC/AC inverter using a piezoelectric transformer to supply power to fluorescent lamps. Usually, the inverter is usually applied to display devices, such as liquid crystal display monitors, liquid crystal display computers or liquid crystal display televisions.

2. Description of Related Arts

CCFLs (cold cathode fluorescent lamps) are wildly employed in display panels. CCFL loads are extensively used to provide backlighting for liquid crystal displays (LCDs), particularly for backlighting LCD monitors and LCD televisions. Such conventional applications require direct current/alternative current inverters (DC/AC inverters) to drive CCFL loads. The critical factors in the design of LCD monitors or LCD televisions include efficiency, cost, size. Additionally, due to liquid crystal display's thin profile, liquid crystal displays can be used in applications where bulkier Cathode Ray Tube (CRT) displays are impractical.

Recent advances in ceramics technology have yielded a new generation of so-called “piezoelectric transformers (PTs)” that are useful in certain applications. These devices, which are constructed using laminated thin layers of ceramic material, exploit a well-known phenomenon called the “piezoelectric effect” to provide AC voltage gain, in contrast to the magnetic field effects relied upon by conventional wound transformers. In contrast to electromagnetic transformers, piezoelectric transformers have a sharp frequency characteristic of the output voltage to input voltage ratio, which has a peak at the resonant frequency. This resonant frequency depends on the material constants and thickness of materials of construction of the transformer including the piezoelectric ceramics and electrodes. Furthermore piezoelectric transformers have a number of advantages over general electromagnetic transformers. The size of piezoelectric transformers can be made much smaller than electromagnetic transformers of comparable transformation ratio, piezoelectric transformers can be made nonflammable, and produce no electromagnetically induced noise. Like conventional transformers, piezoelectric transformers are fairly rugged and can be used to obtain voltage gain in high-voltage applications. Additionally, due to their thin profile, piezoelectric transformers can be used in applications where bulkier wire-wound transformers are impractical. For example, piezoelectric transformers are used in power supplies that provide high-voltage power to fluorescent lamps used as backlights in portable computers. Due to their thin profiles, piezoelectric transformers used in such applications do not adversely affect the desired sleekness of the portable computer enclosure.

Piezoelectric transformers operate most efficiently when operated at frequencies at or near a multiple of a fundamental resonant frequency, which is a function of mechanical characteristics of the transformer such as material type, dimensions, etc. However, piezoelectric transformers are high-impedance devices, and therefore their resonance characteristics as well as other characteristics are sensitive to the loading of the transformer output in operational circuits. Resonant frequency, voltage gain at the resonant frequency, and sharpness of the gain-versus-frequency curve all diminish with increased loading.

The diminishing of resonant frequency and gain with an increase in loading are purposely exploited when a piezoelectric transformer is used to drive a fluorescent lamp. The frequency of the signal applied to the primary inputs of the piezoelectric transformer is slowly swept from a frequency higher than the unloaded resonant frequency toward lower frequencies. As the resonant frequency is approached, the gain increases to the point that the transformer output voltage is sufficiently high to “strike”, or initiate conduction in, the lamp. Once the lamp begins conducting, it presents a much higher load to the transformer, causing the voltage gain and therefore the output voltage of the transformer to drop considerably. The conduction characteristics of the lamp are such that it continues to conduct current at the reduced voltage, so the circuit then enters a stable, lower-voltage operating condition. The intensity of the lamp is regulated by controlling the frequency of the AC drive supplied to the piezoelectric transformer as a function of the lamp current.

Referring to FIG. 1 of the drawings, FIG. 1 shows a conventional resonant half-bridge DC/AC inverter circuit having a piezoelectric ceramic transformer for driving a CCFL load. As shown in FIG. 1, the conventional resonant half-bridge DC/AC inverter circuit 100 comprises a half-bridge power switch circuit 110, a resonant tank 120, a lamp current sensing circuit 130, an integrator 140, a voltage controlled oscillator (VCO) 150, and a half-bridge drive circuit 160. The half-bridge power switch circuit 110 comprises two power switches 110A, 110B which are in a half-bridge configuration. The resonant tank 120 comprises an inductor 121 and a piezoelectric ceramic transformer 122. The integrator 140 comprises an error amplifier 141 which integrates the output of the lamp current sensing circuit 130 and this integrated value affects the operating frequency of the VCO 150. The half-bridge drive circuit 160 provides two driving signals RA and RB.

The half-bridge power switch circuit 110 is electrically connected to a DC power source 180 and powered by the DC power source 180. An output terminal of the half-bridge power switch circuit 110 is electrically connected to an input terminal of the resonant tank 120. An output terminal of the resonant tank 120 is electrically connected to one end of a fluorescent lamp 170. An input of the lamp current sensing circuit 130 is electrically connected to the other end of the fluorescent lamp 170. The inverse terminal of error amplifier 141 of the integrator 140 is electrically connected to the output of the lamp current sensing circuit 130 and the error amplifier 141 integrates the output of the lamp current sensing circuit 130. This integrated value is a voltage-controlled signal RC which affects the operating frequency of the VCO 150. Hence the voltage-controlled signal RC determines the operating frequency of a pulse signal RD which is generated by the VCO 150. The output of the VCO 150 is electrically connected to the half-bridge drive circuit 160. The half-bridge drive circuit 160 generates two sets of fixed duty cycle driving signals RA and RB. The power switches 110A, 110B are driven by the driving signals RA and RB respectively. The upper half of the half-bridge power switch circuit 110 is driven out of phase with the lower half of the half-bridge power switch circuit 110 such that when the power switch 110A is on, the power switch 110B is off, and conversely, when the power switch 110A is off, the power switch 110B is on. Driven in this manner, the output of the half-bridge power switch circuit 110 consists of a square wave voltage.

The conventional resonant half-bridge DC/AC inverter circuit utilizes the high frequency switching of the power switches 110A, 110B to convert a DC voltage powered by the DC power source 180 to a high frequency square wave signal. The high frequency square wave signal is used to drive the resonant tank 120. The resonant tank 120 is the combination of the inductor 121 and the piezoelectric ceramic transformer 122. The combination of the inductor 121 and the piezoelectric ceramic transformer 122 forms a resonant circuit. This results in a sine wave at the output of the resonant tank 120. On the other hand, the resonant tank 120 utilizes the inductor 121 and the piezoelectric ceramic transformer 122 to filter and boost the high frequency square wave signal to a high frequency sine wave signal. The high frequency sine wave signal is used to drive the fluorescent lamp 170.

Referring to FIG. 2 of the drawings, FIG. 2 schematically shows output voltage characteristics of a conventional resonant tank with respect to various frequencies input signal. Therefore, the lamp current could be adjusted by controlling switching frequency of the half-bridge power switch circuit. In other words, the lamp current could be adjusted by controlling the switching frequency of the power switches 110A, 110B.

A resonant tank has many resonant frequencies, and a different gain-versus-frequency characteristic in the neighborhood of each. Generally speaking, it is desirable to design that the operating frequency of the resonant half-bridge DC/AC inverter circuit 100 is higher than the operating frequency of the resonant tank 120. The integrator 140 integrates the output of the lamp current sensing circuit 130 and then generates the stable voltage-controlled signal RC which affects the operating frequency of the VCO 150. Hence the voltage-controlled signal RC can control the VCO 150 to generate different operating frequencies of a pulse signal RD. According negative feedback theory, the voltage-controlled signal RC can raise the operating frequency of a pulse signal RD while the lamp current is increasing and reduce the operating frequency of a pulse signal RD while the lamp current is decreasing. The half-bridge drive circuit 160 utilizes operating frequencies of a pulse signal RD to provides two fixed duty cycle driving signals RA and RB in order to control the power switches 110A, 110B. Therefore, the power switches 110A, 110B have the same and fixed duty cycle control to provide a stable and symmetric alternating current to the fluorescent lamp 170.

Accordingly, the conventional resonant half-bridge DC/AC inverter circuit can provide stable control of lamp current even though the DC power source 180 provides variable DC voltage. However, in practical the drawback of this prior art is that the efficiency of the conventional resonant half-bridge DC/AC inverter circuit is reduced while the DC power source 180 provides higher DC voltage and the operating frequency of the half-bridge power switch circuit 110 operates far away the neighborhood of the resonant frequency. Hence conventional resonant half-bridge DC/AC inverter circuit could not provide good conversion efficiency while the DC power source 180 provides higher DC voltage and the operating frequency of the half-bridge power switch circuit 110 operates far away the neighborhood of the resonant frequency.

### SUMMARY OF THE PRESENT INVENTION

A main object of the present invention is to provide a resonant half-bridge DC/AC inverter that simultaneously varies the operating frequency of the power switches and the duty cycle of the power switches to regulate the output current in order to improve the efficiency of the inverter regardless of the higher DC voltage applied to the inverter.

Another object of the present invention is to provide a resonant half-bridge DC/AC inverter using a piezoelectric transformer to supply power to fluorescent lamps which are wildly employed in display panels and are extensively used to provide backlighting for liquid crystal displays (LCDs), particularly for backlighting LCD monitors, LCD televisions, computer systems and portable DVD, wherein the resonant half-bridge DC/AC inverter simultaneously varies the operating frequency of the power switches and the duty cycle of the power switches to regulate the lamp current in order to improve the efficiency of the inverter regardless of the higher DC voltage applied to the inverter.

Another object of the present invention is to provide a resonant half-bridge DC/AC inverter that provides a symmetric alternating current to supply to fluorescent lamps and a necessary high voltage to ignite fluorescent lamps.

Another object of the present invention is to provide a resonant half-bridge DC/AC inverter further comprising a protection circuit and a dimming control circuit to protect the resonant half-bridge DC/AC inverter under abnormal operation and to adjust the brightness of fluorescent lamps.

Accordingly, in order to accomplish the one or some or all above objects, the present invention provides a resonant half-bridge DC/AC inverter, comprising:

a DC power source providing a DC voltage;

a half-bridge power switch circuit electrically connected to the DC power source being operative to convert the DC voltage to a pulse signal;

a resonant tank electrically connected between an output of the half-bridge power switch circuit and an input of a load being operative to boost and filter the pulse signal to generate an AC power supplied to the load; and

a controller being operative to detect a magnitude of current in the load and a magnitude of a voltage across the load and to generate pulse waveforms for turning on and off the half-bridge power switch circuit, wherein the controller substantially instantaneously varies a frequency of the pulse waveforms and a duty cycle of the pulse waveforms so as to operate the resonant half-bridge DC/AC inverter near a neighborhood of a resonant frequency of the resonant tank regardless of a conduction state of the load.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic diagram of a conventional resonant half-bridge DC/AC inverter circuit having a piezoelectric ceramic transformer for driving a CCFL load.

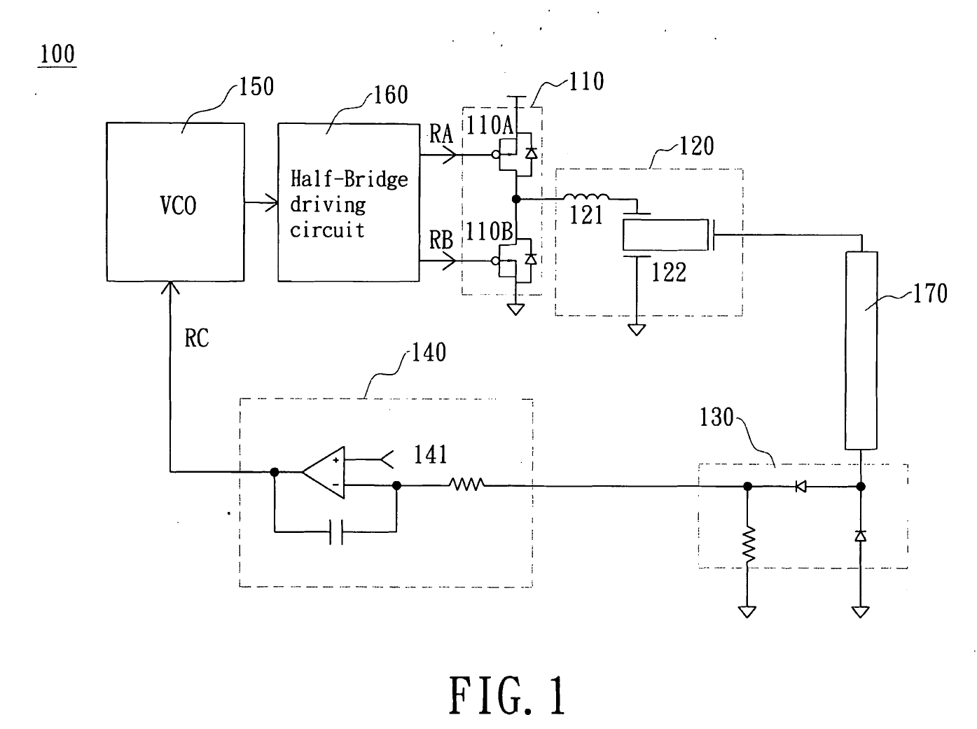

FIG. 2 is a schematic diagram of output voltage characteristics of a conventional resonant tank with respect to various frequencies input signal.

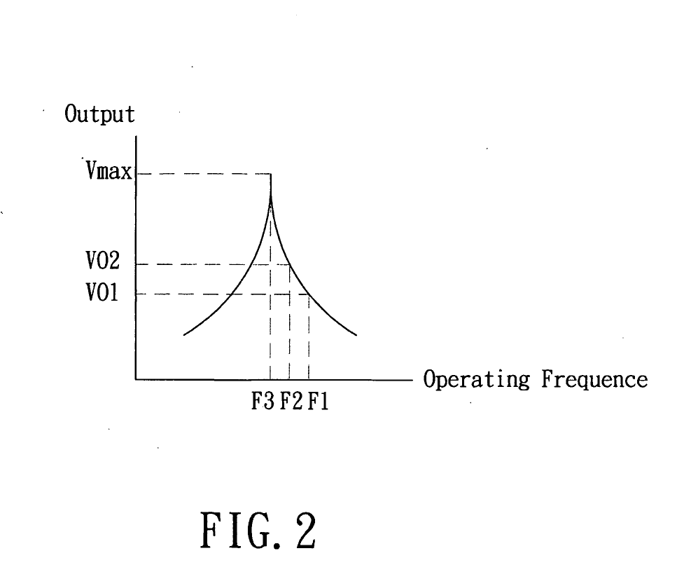

FIG. 3 is an exemplary circuit diagram of a resonant half-bridge DC/AC inverter circuit having a piezoelectric ceramic transformer according to a preferred embodiment of the present invention.

### DETAILED DESCRIPTION OF THE PREFERRED EMBODIMENT

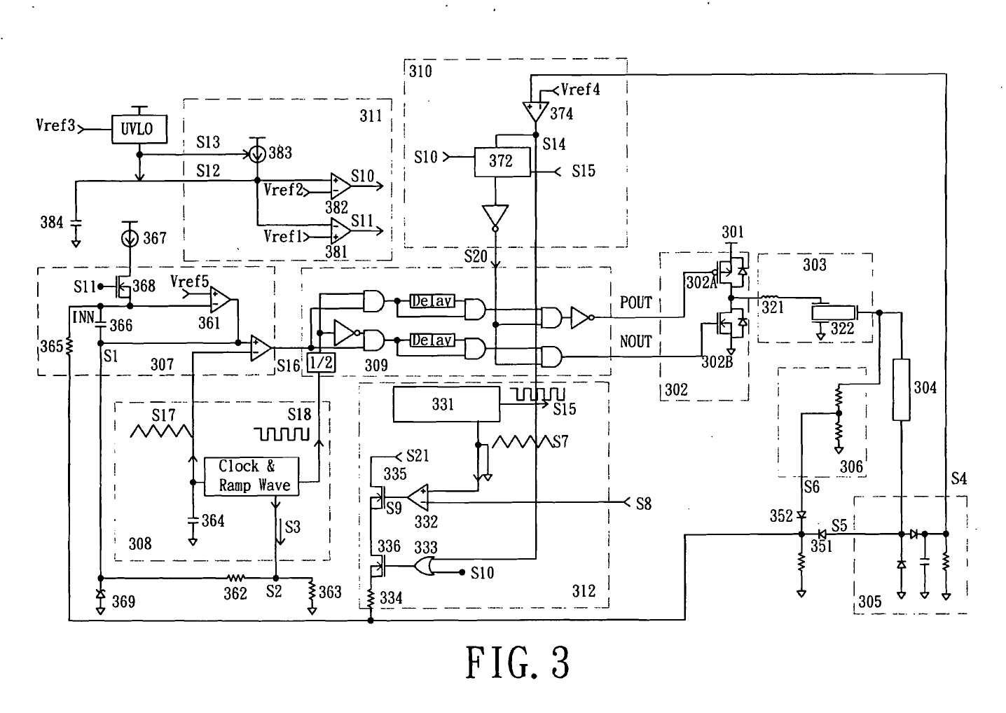

Referring to FIG. 3, an exemplary circuit diagram of a resonant half-bridge DC/AC inverter circuit having a piezoelectric ceramic transformer according to a preferred embodiment of the present invention is illustrated. The resonant half-bridge DC/AC inverter circuit 300 includes a DC power source 301, a half-bridge power switch circuit 302, a resonant tank 303, a lamp current sensing circuit 305, a lamp voltage sensing circuit 306, a pulse width modulator 307, a triangle wave generator 308, a half-bridge drive circuit 309, a protection circuit 310, a timer 311, and a dimming control circuit 312. The half-bridge power switch circuit 302 comprises two power switches 302A, 302B which are in a half-bridge configuration. The power switch 302A could be a p-type MOSFET. The power switch 302B could be a n-type MOSFET. However, the power switches 302A, 302B are not limited to MOSFET and could be any type of transistor switch such as BJT. The resonant tank 303 comprises an inductor 321 and a piezoelectric ceramic transformer 322.

The half-bridge power switch circuit 302 is electrically connected to the DC power source 301 and powered by the DC power source 301. An output terminal of the half-bridge power switch circuit 302 is electrically connected to an input terminal of the resonant tank 303. An output terminal of the resonant tank 303 is electrically connected to one end of a fluorescent lamp 304. An input of the lamp current sensing circuit 305 is electrically connected to one end of the fluorescent lamp 304. An input of the lamp voltage sensing circuit 306 is electrically connected to the other end of the fluorescent lamp 304. An output of the lamp current sensing circuit 305 and an output of the lamp voltage sensing circuit 306 are electrically connected to the pulse width modulator 307 and feeds back a lamp current sensing signal and a lamp voltage sensing signal to the pulse width modulator 307.

The pulse width modulator 307 comprises an error amplifier 361, a comparator 364, an integral resistor 365, an integral capacitor 366, a current source 367, and a switch 368, wherein an inverse integrator consists of an error amplifier 361, an integral resistor 365, and an integral capacitor 366. An inverting terminal of the error amplifier 361 is electrically connected to the current source 367 via the switch 368. An output terminal S1 of the error amplifier 361 is electrically connected to the triangle wave generator 308 via a resistor 362. An output terminal S16 of the pulse width modulator 307 is electrically connected to the half-bridge drive circuit 309. The half-bridge drive circuit 309 is electrically connected to the half-bridge power switch circuit 302.

According to the preferred embodiment of the present invention, an output terminal S2 of the triangle wave generator 308 is electrically connected to a grounding resistor 363. Additionally, the triangle wave generator 308 comprises another terminal electrically connected to a capacitor 364. The value of a current S3 passing through the output terminal S2 of the triangle wave generator 308 and the capacitance of the capacitor 364 determine the operating frequency of the triangle wave generator 308. The operating frequency of the triangle wave generator 308 increases when the current S3 increases. The operating frequency of the triangle wave generator 308 is determined by an output signal at the output terminal S1 of the error amplifier 361 and the current S3 because the resistor 362 is connected between the output terminal S1 of the error amplifier 361 and the output terminal S2 of the triangle wave generator 308. In this embodiment of the present invention, when the output signal at the output terminal S1 of the error amplifier 361 is zero voltage, the resistor 362 is in parallel with the grounding resistor 363 with respect to the output terminal S2. Hence the equivalent load resistance with respect to the triangle wave generator 308 is smallest and then the current S3 passing through the output terminal S2 of the triangle wave generator 308 is highest. In other words, the operating frequency of the triangle wave generator 308 is highest. On the contrary, when the output voltage at the output terminal S1 of the error amplifier 361 is close to the voltage at the output terminal S2, the current passing through the resistor 362 is zero. Hence the equivalent load resistance with respect to the triangle wave generator 308 is just only the grounding resistor 363. The current S3 passing through the output terminal S2 of the triangle wave generator 308 becomes smaller and then the operating frequency of the triangle wave generator 308 also becomes smaller. When the values of the resistor 362, the grounding resistor 363, and the capacitor 364 are fixed, the operating frequency of the triangle wave generator 308 is determined by the voltage at the output terminal S1 of the error amplifier 361. In other words, when the voltage at the output terminal S1 of the error amplifier 361 decreases, the operating frequency of the triangle wave generator 308 increases, and vice versa. In this embodiment of the present invention, the triangle wave generator 308 not only generates a triangle wave S17 but also a pulse signal S18 having the same frequency with the triangle wave S17, wherein the pulse signal S18 is supplied to the half-bridge drive circuit 309 to generate driving signals. However, it is not intended to o limit the invention to the triangle wave. It should be appreciated that any ramp signals or sawtooth wave signals could be made in the embodiments described by persons skilled in the art.

The lamp current sensing circuit 305 is in series with the fluorescent lamp 304 and provides a signal S4 to indicate the conduction state of the fluorescent lamp 304 and a signal S5 to indicate the current passing through the fluorescent lamp 304. The lamp voltage sensing circuit 306 is in parallel with the fluorescent lamp 304 and provides a signal S6 to indicate the voltage at the end of the fluorescent lamp 304.

The half-bridge drive circuit 309 generates two driving signals POUT and NOUT. The timer 311 comprises two sets of comparators 381, 382, and a current source 383. The dimming control circuit 312 comprises a dimming frequency generator 331 generating a triangle wave S7 and a pulse signal S15, a comparator 332, and an OR gate 333. The triangle wave S7 is applied to a non-inverting terminal of the comparator 332 and a dimming control voltage S8 is applied to an inverting terminal of the comparator 332. The comparator 332 compares the triangle wave S7 and the dimming control voltage S8 to generate a dimming pulse signal S9. The OR gate 333 is used to control the timing when the dimming pulse signal S9 could be applied to the error amplifier 361 of the pulse width modulator 307.

In this embodiment of the present invention, the timer 311 utilizes the current source 383 to charge a timer capacitor 384 so that a voltage S12 across the timer capacitor 384 increases with time. When the voltage S12 is lower than a reference voltage Vref1, the timer 311 utilizes a comparator 381 to output a reset signal S11. When the voltage S12 is larger than a reference voltage Vref2, the timer 311 utilizes a comparator 382 to output a time out signal S10. The current source 383 is controlled by an indicative signal S13 outputted from a system voltage source. When a system voltage of the system voltage source is lower than reference voltage Vref3, the indicative signal S13 communicates with the current source 383 to turn off the current source 383 and also grounds the timer capacitor 384. Therefore, it could be assured that the timer capacitor 384 is charged from zero voltage and the timer 311 should be reset each start of the resonant half-bridge DC/AC inverter circuit.

In this embodiment of the present invention, the protection circuit 310 comprises a comparator 374 and a logic control circuit 372. The signal S4 provided by the lamp current sensing circuit 305 and a reference voltage Vref4 are applied to the comparator 374 to determine the conduction state of the fluorescent lamp 304. When the signal S4 is larger than the reference voltage Vref4, the fluorescent lamp 304 is treated as ignition and the comparator 374 outputs a signal S114 to indicate that the fluorescent lamp 304 is ignited. The protection circuit 310 determines the execution of the protection action or not according to the signal S14, the time out signal S11, and the pulse signal S15.

Under normal operation, the timer 311 utilizes the current source 383 to charge a timer capacitor 384 so that a voltage S12 across the timer capacitor 384 increases with time. When the voltage S12 is lower than a reference voltage Vref1, the timer 311 utilizes a comparator 381 to output a reset signal S11 so that a switch 368 is turned on and the current source 367 is electrically connected to the inverting terminal of the error amplifier 361. Hence the current source 367 enforces that a voltage at the inverting terminal of the error amplifier 361 is higher than a reference voltage Vref5 so that the output of the error amplifier 361 is zero. At this time, the output of the pulse width modulator 307 is zero. The operating frequency of the voltage-controlled-frequency triangle wave generator 308 is far way and higher than the resonant frequency of the resonant tank 303.

When the voltage S12 is larger than a reference voltage Vref1, the switch 368 is turned off so that the pulse width modulator 307 starts to work. The voltage at the inverting terminal of the error amplifier 361 is lower than the reference voltage Vref5 plus a conduction voltage of a diode 352, the output signal of the error amplifier 361 gradually increases because of negative feedback control theory. The comparator 364 compares the output signal of the error amplifier 361 with the triangle wave S17 to generate a pulse width modulation signal S16. The pulse width modulation signal S16 and the pulse signal S18 are applied to the half-bridge drive circuit 309 to generate driving signals POUT and NOUT which drive two power switches 302A, 302B respectively. The output of the pulse width modulator 307 determines the turned-on duty cycle of the driving signals POUT and NOUT. When the output of the pulse width modulator 307 is higher, it makes larger turned-on duty cycle of the driving signals POUT and NOUT. With such design, the power switches 302A, 302B are driven by a higher frequency and less duty cycle signals POUT and NOUT when the supply voltage is higher. When the power switches 302A, 302B are driven by less duty cycle signals POUT and NOUT, less power transferred to the load may prevent the operating frequency far away from the resonant frequency of the resonant tank 303 as the prior art.

Before the ignition of the fluorescent lamp 304, the voltage at the end of the fluorescent lamp 304 increases because the duty cycle of the pulse width modulation signal S16 gradually increases and the frequency of the pulse width modulation signal S16 gradually decreases. The lamp voltage sensing circuit 306 detects the voltage at the end of the fluorescent lamp 304 and provides a signal S6 to indicate the voltage at the end of the fluorescent lamp 304. When the voltage of the signal S6 is greater than the reference voltage Vref5 plus the conduction voltage of the diode 352, the output of the error amplifier 361 becomes smaller and then the duty cycle of the pulse width modulation signal S16 is reduced and the frequency of the pulse width modulation signal S16 is increased to reduce the power delivery to fluorescent lamp 304. If this result causes the voltage of the signal S6 is smaller than the reference voltage Vref5 plus the conduction voltage of the diode 352, the output of the error amplifier 361 becomes larger. Therefore, the voltage applied to the fluorescent lamp 304 could be regulated and stabilized because of negative feedback control theory.

Once the fluorescent lamp 304 is ignited and reaches steady operation, the voltage across the fluorescent lamp 304 will suddenly drop to half of the ignition voltage of the fluorescent lamp 304 so that the lamp voltage sensing circuit 306 does not work because the lamp voltage sensing circuit 306 could not detect an enough high voltage.

The lamp current sensing circuit 305 provides a signal S4 to the lamp current sensing circuit 305 and a signal S5 to the pulse width modulator 307 to stabilize the current passing through the fluorescent lamp 304 at a fixed value via feedback control.

In this embodiment of the present invention, the function of the diodes 351 and 352 is to utilize the characteristic of the great difference between the ignition voltage and the normal operation voltage of the fluorescent lamp (for example 2˜2.5 times). Before the ignition of the fluorescent lamp 304, the diode 352 is conductive and the diode 351 is non-conductive so that the signal S6 provided by the lamp voltage sensing circuit 306 is applied to the pulse width modulator 307. Once the fluorescent lamp 304 is ignited, the voltage across the fluorescent lamp 304 drops and the lamp current increases so that the diode 352 is non-conductive and the diode 351 is conductive. Hence the signal S5 provided by the lamp current sensing circuit 305 is applied to the pulse width modulator 307. As a result, the inverter could provide a stable high voltage to the fluorescent lamp 304 during start operation and a stable current to the fluorescent lamp 304 during normal operation.

The detail description of the protection circuit in this embodiment of the present invention is described as below:

Before the fluorescent lamp 304 connected to the inverter, the signal S14 automatically is delivered to the logic control circuit 372 to indicate that the fluorescent lamp 304 is not ignited. In order to provide enough time to ignite the fluorescent lamp 304, the time out signal S10 is delivered to the protection circuit 310 to enforce the logic control circuit 372 to ignore that the signal S14 indicates the information of the non-ignition of the fluorescent lamp 304. Once the time reaches the preset value, the inverter utilizes another digital timer to calculate time on the base of the pulse signal S15. If the fluorescent lamp 304 still is not ignited after several clock cycles, the logic control circuit 372 outputs a signal S20 to stop the operation of the half-bridge drive circuit 309 and the conduction of the power switches 302A, 302B. In this embodiment of the present invention, once the protection circuit 310 stops the power switches 302A, 302B, the inverter 300 must be turned off and restarted to get rid of the protection action.

When the fluorescent lamp 304 is broken and open during operation, the signal S14 is delivered to the logic control circuit 372 to indicate the information of the non-ignition of the fluorescent lamp 304. The logic control circuit 372 receives the time out signal S10 provided by the timer 311. The logic control circuit 372 does not work until the time out signal S10 is delivered to the logic control circuit 372. Once the time is over the preset value, the inverter utilizes another digital timer to calculate time on the base of the pulse signal S15. If the fluorescent lamp 304 still is not ignited after several clock cycles, the logic control circuit 372 outputs a signal S20 to stop the operation of the half-bridge drive circuit 309 and the conduction of the power switches 302A, 302B. In this embodiment of the present invention, once the protection circuit 310 stops the power switches 302A, 302B, the inverter 300 must be turned off and restarted to get rid of the protection action.

The dimming control circuit 312 utilizes a lower frequency than the operating frequency of the fluorescent lamp 304 to stop or recover to deliver power to the fluorescent lamp 304. The adjustment of the ratio of lightness and darkness is utilized to adjust the brightness of the fluorescent lamp 304. The dimming frequency control generally is controlled above 200 Hz in order to avoid the user's feeling of flicker caused by lower dimming frequency. The dimming control circuit 312 is enabled by two signals. One is the signal S14 which indicates the conduction state of the fluorescent lamp. The other is the time out signal S10 provided by the timer 311. When the signal S14 indicates that the fluorescent lamp is conductive or the time out signal S10 indicates that time is out, a switch 336 is turned on to control the output of the dimming signal. A dimming voltage S21 of the dimming control circuit 312 is higher than the reference voltage Vref5. When the dimming voltage S21 is delivered to the pulse width modulator 307 through switched 336, 335 and the resistor 334, the output voltage of the error amplifier 361 of the pulse width modulator 307 becomes smaller and causes the inverter to stop the power delivery to the fluorescent lamp. When the dimming pulse signal S9 turns off the switch 335, the dimming voltage S21 is not delivered to the pulse width modulator 307. It is an open circuit between the dimming voltage S21 and the pulse width modulator 307 so that the inverter recovers to deliver the power to the load.

In this embodiment of the present invention, the dimming frequency generator 331 generates a triangle wave S7. The comparator 332 compares the triangle wave S7 and the dimming control voltage S8 to generate the dimming pulse signal S9. The dimming pulse signal S9 has different pulse widths. The present invention utilize a low frequency control to control the ratio of the power stop period or the power supply period each cycle in order to achieve the brightness adjustment. However, the conduction state of the fluorescent lamp 304 could determine when starts to proceed the dimming control and ensure the fluorescent lamp 304 has enough time and continuous power to be ignited.

In this embodiment of the present invention, in order to the interference between the internal clock of LCD and the low frequency dimming control, the dimming control voltage S8 could be a low frequency pulse generated by related internal clock of LCD. When the amplitude of the dimming control voltage S8 is greater than the peak value of the triangle wave S7 and smaller than the valley value of the triangle wave S7, the duty cycle and frequency of the dimming pulse signal S9 is completely determined by the duty cycle and frequency of the dimming control voltage S8. Hence it could reduce the difference frequency interference of user's sense of sight caused by the difference between operating frequency of dimming control and the operating frequency of LCD.

In order to provide a symmetric alternating current to drive the fluorescent lamp 304, the upper half of the half-bridge power switch circuit 110 is driven out of phase with the lower half of the half-bridge power switch circuit 110 such that when the power switch 110A is on, the power switch 110B is off, and conversely, when the power switch 110A is off, the power switch 110B is on. Driven in this manner, the upper half of the half-bridge power switch circuit 110 and the lower half of the half-bridge power switch circuit 110 have the same duty cycle and alternatively turned on and off with 180° phase shift.

Additionally, while the present invention makes specific reference to CCFLs, the present invention is equally applicable for driving many types of lamps and tubes known in the art, such as: metal halide lamps, sodium vapor lamps, and/or x-ray tubes.

Furthermore, while the present invention makes specific reference to piezoelectric, the present invention is equally applicable for any types of transformers known in the art, such as: electromagnetic transformers.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A resonant DC/AC inverter, comprising:
a DC power source providing a DC voltage;
a half-bridge power switch circuit electrically connected to said DC power source being operative to convert said DC voltage to a pulse signal;
a resonant tank electrically connected between an output of said half-bridge power switch circuit and an input of a load being operative to boost and filter said pulse signal to generate an AC power supplied to said load; and
a controller being operative to detect a magnitude of current in said load and a magnitude of a voltage across said load and to generate pulse waveforms for turning on and off said half-bridge power switch circuit, wherein said controller substantially instantaneously varies a frequency of said pulse waveforms and a duty cycle of said pulse waveforms so as to operate said resonant DC/AC inverter near a neighborhood of a resonant frequency of said resonant tank regardless of a conduction state of said load.

2. The resonant DC/AC inverter, as recited in claim 1, wherein said load is a gas discharge lamp.

3. The resonant DC/AC inverter, as recited in claim 2, wherein said lamp is selected from a group consisting of a cold cathode fluorescent lamp, a metal halide lamp, a sodium vapor lamp, a x-ray tube, and an External Electrode Fluorescent Lamp.

4. The resonant half-bridge DC/AC inverter, as recited in claim 1, wherein said controller comprising:
a current sensing circuit electrically connected to said load being operative to detect a load current;
a voltage sensing circuit electrically connected to said load being operative to detect a voltage at one end of said load;
a pulse width modulator electrically connected to said current sensing circuit and said voltage sensing circuit being operative to generate pulse waveforms for turning on and off said half-bridge power switch circuit, wherein said frequency and said duty cycle of said pulse waveforms are substantially instantaneously varied;
a triangle wave generator electrically connected to said pulse width modulator being operative to generate voltage controlled frequency triangle waveforms for adjusting said frequency and said duty cycle of said pulse waveforms; and
a half-bridge drive circuit electrically connected to said triangle wave generator being operative to generate driving signals to operate said resonant half-bridge DC/AC inverter near a neighborhood of a resonant frequency of said resonant tank regardless of a conduction state of said load.

5. The resonant DC/AC inverter, as recited in claim 3, wherein said controller comprising:
a lamp current sensing circuit electrically connected to said lamp being operative to detect a load current;
a lamp voltage sensing circuit electrically connected to said load being operative to detect a voltage at one end of said lamp;
a pulse width modulator electrically connected to said lamp current sensing circuit and said lamp voltage sensing circuit being operative to generate pulse waveforms for turning on and off said half-bridge power switch circuit, wherein said frequency and said duty cycle of said pulse waveforms are substantially instantaneously varied;
a triangle wave generator electrically connected to said pulse width modulator being operative to generate voltage controlled frequency triangle waveforms for adjusting said frequency and said duty cycle of said pulse waveforms; and
a half-bridge drive circuit electrically connected to said triangle wave generator being operative to generate driving signals to operate said resonant half-bridge DC/AC inverter near a neighborhood of a resonant frequency of said resonant tank regardless of a conduction state of said lamp.

6. The resonant DC/AC inverter, as recited in claim 1, wherein said controller further comprises:
a timer providing a timer signal; and
a protection circuit electrically connected to said voltage sensing circuit and said timer being operative to utilize a feedback result of said voltage sensing circuit and said timer signal to determine whether said half-bridge power switch circuit is keeping conductive or not.

7. The resonant DC/AC inverter, as recited in claim 4, wherein said controller further comprises:
a timer providing a timer signal; and
a protection circuit electrically connected to said voltage sensing circuit and said timer being operative to utilize a feedback result of said voltage sensing circuit and said timer signal to determine whether said half-bridge power switch circuit is keeping conductive or not.

8. The resonant DC/AC inverter, as recited in claim 5, wherein said controller further comprises:
a timer providing a timer signal; and
a protection circuit electrically connected to said voltage sensing circuit and said timer being operative to utilize a feedback result of said voltage sensing circuit and said timer signal to determine whether said half-bridge power switch circuit is keeping conductive or not.

9. The resonant DC/AC inverter, as recited in claim 8, wherein said resonant DC/AC inverter further comprises a dimming control circuit electrically connected to said current sensing circuit and said protection circuit to be operative to utilize feedback results of said lamp current sensing circuit and said lamp voltage sensing circuit to determine a timing of enabling said dimming control circuit to adjust a brightness of said lamp.

10. The resonant DC/AC inverter, as recited in claim 9, wherein said dimming control circuit receives a dimming control voltage to adjust said brightness of said lamp.

11. The resonant DC/AC inverter, as recited in claim 1, wherein said pulse signal is selected from a group consisting of a square wave signal, a quasi sine wave, and a quasi square wave.

12. A lamp driving system, comprising:
a DC power source providing a DC voltage;
a half-bridge power switch circuit electrically connected to said DC power source being operative to convert said DC voltage to a pulse signal;
a resonant tank electrically connected between an output of said half-bridge power switch circuit and an input of a lamp being operative to boost and filter said pulse signal to generate an AC power supplied to said lamp; and
a controller being operative to detect a magnitude of current in said lamp and a magnitude of a voltage across said lamp and to generate pulse waveforms for turning on and off said half-bridge power switch circuit, wherein said controller substantially instantaneously varies a frequency of said pulse waveforms and a duty cycle of said pulse waveforms so as to operate said resonant half-bridge DC/AC inverter near a neighborhood of a resonant frequency of said resonant tank regardless of a conduction state of said lamp.

13. The lamp driving system, as recited in claim 12, wherein said lamp is selected from a group consisting of a cold cathode fluorescent lamp, a metal halide lamp, a sodium vapor lamp, a x-ray tube, and an External Electrode Fluorescent Lamp.

14. The lamp driving system, as recited in claim 12, wherein said controller comprising:
a current sensing circuit electrically connected to said lamp being operative to detect a lamp current;
a voltage sensing circuit electrically connected to said lamp being operative to detect a voltage at one end of said lamp;
a pulse width modulator electrically connected to said current sensing circuit and said voltage sensing circuit being operative to generate pulse waveforms for turning on and off said half-bridge power switch circuit, wherein said frequency and said duty cycle of said pulse waveforms are substantially instantaneously varied;
a triangle wave generator electrically connected to said pulse width modulator being operative to generate voltage controlled frequency triangle waveforms for adjusting said frequency and said duty cycle of said pulse waveforms; and
a half-bridge drive circuit electrically connected to said triangle wave generator being operative to generate driving signals to operate said resonant half-bridge DC/AC inverter near a neighborhood of a resonant frequency of said resonant tank regardless of a conduction state of said lamp.

15. The lamp driving system, as recited in claim 14, wherein said controller further comprises:
a timer providing a timer signal; and
a protection circuit electrically connected to said voltage sensing circuit and said timer being operative to utilize a feedback result of said voltage sensing circuit and said timer signal to determine whether said half-bridge power switch circuit is keeping conductive or not.

16. The lamp driving system, as recited in claim 15, wherein said lamp driving system further comprises a dimming control circuit electrically connected to said current sensing circuit and said protection circuit to be operative to utilize feedback results of said lamp current sensing circuit and said lamp voltage sensing circuit to determine a timing of enabling said dimming control circuit to adjust a brightness of said lamp.

17. The lamp driving system, as recited in claim 16, wherein said dimming control circuit receives a dimming control voltage to adjust said brightness of said lamp.

18. The lamp driving system, as recited in claim 12, wherein said pulse signals selected from a group consisting of a square wave signal, a quasi sine wave, and a quasi square wave.
